(19) United States
(12) Patent Application Publication
(10) Pub. No.: US 2018/0338218 A1
(43) Pub. Date: Nov. 22, 2018

(54) INFORMATION RESOURCE PUSHING AND ISSUING TECHNIQUES

(71) Applicant: CHIGOO (SHANGHAI) INTERACTIVE TECHNOLOGY CO., LTD., Shanghai (CN)

(72) Inventors: Tao Chen, Shanghai (CN); Ming Lei, Shanghai (CN)

(21) Appl. No.: 15/702,052

(22) Filed: Sep. 12, 2017

Related U.S. Application Data
(63) Continuation of application No. PCT/CN2017/089193, filed on Jun. 20, 2017.

(30) Foreign Application Priority Data
May 16, 2017 (CN) 201710346892.4

(51) Int. Cl. H04W 4/02; H04W 36/32; H04L 29/08; H04W 8/24; H04W 8/08

(52) U.S. Cl. CPC H04W 4/023; H04W 36/32; H04W 4/022; H04W 8/245; H04W 8/08; H04L 67/26

(57) ABSTRACT

An information resource pushing method, issuing method and system are provided. Servers receive information resource requests from each of public mobile devices in different issuing regions, acquire the related information of issuing region where each of public mobile device is located and a known starting point near to the public mobile device, and determine address information of at least one node in at least one trip starting from the starting point and return them to each of public mobile devices. Each of the public mobile devices identifies an issuing destination matched with the address information from the information resource issuing table issued by the server so as to acquire and display information contents according to the issuing destination and related other information. Thus unified networking display of information resources in multiple public places can be realized.

### CROSS REFERENCE TO RELATED APPLICATIONS

This application is a continuation of International Application No. PCT/CN2017/089193, filed on Jun. 20, 2017, which is based upon and claims priority to Chinese Patent Application No. 201710346892.4, filed on May 16, 2017, the entire contents of each of which are incorporated herein by reference.

### TECHNICAL FIELD

The present application relates to the technical field of information delivery and, more particularly, to information resource pushing and issuing techniques.

### BACKGROUND

A variety of positioning technologies have been developed, such as satellite positioning (GPS/BDS), radio frequency identification signal positioning/infrared identification signal positioning (RFID/IRID positioning), wireless local area network positioning (WLAN-AP), BLE Beacon positioning, LED white light positioning, geomagnetic field positioning, and visual positioning signal-based positioning. At present, based on the extensive use of positioning technologies, there are various schemes of using the positioning technologies to realize instant positioning information pushing. For example, based on a location of a user's mobile phone, relevant food and shopping information, etc., near the user's location can be pushed to the user.

However, these positioning technologies suffer from several drawbacks. For instance, the mobile phone in people's daily life plays many roles (such as personal assistant, social tools, office tools, entertainment tools, etc.), and therefore takes too many tasks and acquires numerous information resources every day. Thus, when the mobile phone serves as a pushing carrier for information resources, the information resources may become flooded in network information, resulting in some of the information resources often being ignored by mobile users. Not only that, since the mobile phone is a private device, whether to install certain applications and whether to use or watch certain applications are entirely based on the user's own decisions, so the arrival rate of public information dissemination is very low. That is, because of the privacy essential of the mobile phone, such information dissemination may not effectively reach each mobile phone user. Therefore, the mobile phone is not suitable for some public places as a resource display carrier. Conventionally, information resources corresponding to a location where the mobile device is located are pushed on the basis of the current location of the mobile device, but the user's upcoming trip or location is not predicted, and hence information resources related to the trip or future locations will not be pushed.

It is known to display information in a number of public places, such as airports, through large fixed electronic display screens, or display piles. These large electronic display screens or display piles have certain information dissemination capacity, but the dissemination effect is restrained by their fixed locations. In addition, as large space resources are occupied by their large volumes, and public service standards limit their deployment, only a limited number of devices can be arranged for a single boarding gate, and the devices at fixed locations are prone to being shielded by crowds, hence failing to effectively cover a large number of customers.

On the other hand, because the property rights, the operation rights, and the management rights of the airports belong to different entities, different airports and even the same airport often purchase these fixed large electronic display screens or display piles for different periods of time, resulting in different hardware specifications and display capabilities. Each airport then cooperates with the respective selected information resource provider to acquire information resource pushing services. As a result, the display of information resources is restrained by the sites of different airports, different specifications of display devices, and different cooperating resource providers. It is therefore difficult to display unified public information resources in public places among a number of places around the world (for example, in the whole city, in the whole province, in the whole country, around the world). For example, due to restrictions from existing property rights, operation rights, management rights, fixed device specifications, and technical means, information on flight destinations can be displayed only in a boarding gate of a certain departure airport, but not in boarding gates of airports nationwide or worldwide to the same destination. For example, using Shanghai as an example target city, synchronously displaying tourism information on Shanghai at all boarding gates of airports nationwide or worldwide for global or national flights to Shanghai cannot be realized.

### SUMMARY

The embodiments of the present invention relate to an information resource pushing method, an information resource issuing method, a server, and a system for solving one or more of the problems present in the prior art.

As used herein, the term “information resources” may refer to any suitable type of data or information that is displayed, delivered, transmitted, or otherwise presented to a user. Thus, the term “information resource” or “information resources” may be considered synonymous with terms such as “data” or “information.”

Moreover, the terms “screened,” “screened out,” “screening out,” etc., as used herein, may refer to any suitable techniques used to identify, find out, or otherwise determine the relevant information that is described. For example, the public mobile device may identify an issuing destination matched with the address information from the information resource issuing table issued by the server. Thus, such screening terminology may be considered synonymous with ascertaining certain types of data and/or information.

According to a first aspect of the present invention, there is provided an information resource pushing method applied to a server, comprising the following steps:

receiving, via the server, an information resource issuing request from an information resource provider, the information resource issuing request including N issuing regions, information content IDs, and an issuing destination and an issuing time period related to respective information content IDs, wherein N is a positive integer;

generating, via the server, N information resource issuing tables corresponding to N issuing regions according to the received information resource issuing request, the information resource issuing table including the information content ID, and the issuing destination and the issuing time period related to the information content ID;

sending, via the server, the N information resource issuing tables to a public mobile device in the N related issuing regions;

acquiring, via the server, information on an i-th issuing region and information on a known starting point adjacent to the location of the public mobile device according to the information resource request received from the public mobile device in the i-th issuing region, and determining, via the server, address information of the at least one node in the at least one trip starting from the known starting point in the i-th issuing region, wherein i is a positive integer bigger than 0 and smaller or equal to N;

returning, via the server, the determined address information of the at least one node in the at least one trip to the public mobile device in the i-th issuing region for the public mobile device in the i-th issuing region to screen out an issuing destination matched with the address information from the information resource issuing table issued by the server, and further acquiring, via the server, the corresponding information content according to the screened issuing destination and on the basis of the related information content ID and displaying the information content within the corresponding issuing time period.

According to a second aspect of the present invention, there is provided a nonvolatile computer storage medium for storing computer executable programs therein, the computer executable programs being used to execute the information resource pushing method mentioned above.

According to a third aspect of the present invention, there is provided a server comprising: at least one processor, a wireless communication device capable of communicating with a public mobile device, and a memory, wherein the memory stores programs executed by the at least one processor, the programs being executed by the at least one processor so that the at least one processor is capable of executing the information resource pushing method mentioned above.

According to a fourth aspect of the present invention, there is provided an information resource issuing method applied to an information resource system including a server and public mobile devices deployed in a plurality of regions, the method comprising:

receiving, via the server, an information resource issuing request from an information resource provider, the information resource issuing request including N issuing regions, information content IDs, and an issuing destination and an issuing time period related to respective information content IDs, wherein N is a positive integer;

generating, via the server, N information resource issuing tables corresponding to the N issuing regions according to the received information resource issuing request, the information resource issuing table including the information content ID, and the issuing destination and the issuing time period related to the information content ID;

sending, via the server, the N information resource issuing tables to public mobile devices in the corresponding N issuing regions;

detecting, via the public mobile device, first location information in which it is located, wherein the public mobile device is located in the i-th issuing region among the plurality of regions, wherein i is a positive integer bigger than 0 and smaller or equal to N;

when a distance between the first location information and second location information of a known starting point in the i-th issuing region is less than a predetermined distance threshold, counting, via the public mobile device, a duration of the public mobile device resided within a radius range of the predetermined distance threshold from the starting point;

when the duration reaches a predetermined time threshold, sending, via the public mobile device, an information resource request for requesting address information of at least one node in at least one trip starting from the starting point, the information resource request including information on the i-th issuing region and the information on the starting point;

determining, via the server, address information of the at least one node in the at least one trip starting from the starting point in the i-th issuing region according to the information on the i-th issuing region and the information on the starting point acquired through the information resource request;

screening out, via the public mobile device, an issuing destination matched with the address information from the information resource issuing table received from the server according to the address information returned by the server;

determining, via the public mobile device, related information content ID according to the screened issuing destination; and

acquiring, via the public mobile device, the corresponding information content according to the determined information content ID and displaying the information content within the corresponding issuing time period.

According to fifth aspect of the present invention, there is provided an information resource system, comprising the server mentioned above and public mobile devices capable of being deployed within different regions, the public mobile device comprising:

at least one processor;

a wireless communication device configured to communicate with the server;

at least one display; and

a memory, wherein the memory is configured to store programs executed by the at least one processor, the programs being executed by the at least one processor such that the at least one processor is capable of executing the following steps:

receiving an information resource issuing table issued by the server according to the i-th issuing region of N issuing regions, the information resource issuing table at least including information content IDs, and an issuing destination and an issuing time period related to respective information content IDs, wherein N is a positive integer, and i is a positive integer bigger than 0 and smaller or equal to N

detecting first location information in which the public mobile device is located

when a distance between the first location information and second location information of a known starting point in the i-th issuing region is less than a predetermined distance threshold, counting a duration of the public mobile device resided within a radius range of the predetermined distance threshold from the starting point

when the duration reaches a predetermined time threshold, sending, to the server, an information resource request for requesting address information of at least one node in at least one trip starting from the starting point, the information resource request including information on the i-th issuing region and the information on the starting point;

screening out an issuing destination matched with the address information from the information resource issuing table according to the address information returned by the server; and

acquiring the corresponding information content corresponding to the related information content ID according to the screened issuing destination, and displaying the information content within the corresponding issuing time period.

Compared with conventional techniques, the above solution provided by the present invention is technical in nature and has at least the following advantages. Additional and alternate advantages are further provided throughout this disclosure, and are also pointed out in detail below in the “technical advantages” section.

The present invention realizes the centralized and unified management of information resources that need to be displayed in different public places, and ensures the display validity, accuracy, and uniformity of information resources on public mobile devices in different regions by interacting with public mobile terminals in different regions.

With the system described herein in the embodiments herein, the management and display of information resources are well integrated with the public mobile devices, and are not restrained by fields and display devices by movement of the public mobile devices. This addresses existing issues regarding the display of information resources being restrained by property rights, operation rights, and management rights of information display in public places. The system provided by the present invention provides technical advantages in that it is easier for the public mobile devices to be deployed in different areas for public use that may be delivered via hardware free of charge and/or in a low cost manner, such as in different sites in a public place, different places in a city, different cities in a country, or any country on a global scale. Therefore, not only is the cost effectively reduced, but the restriction from the information resource display areas is removed, thereby achieving the dissemination of information resources on a global scale.

Moreover, compared with existing fixed display methods, the present invention further takes into account changes in location, predicts based on the user's travel schedule, and pushes information accordingly, thereby realizing more targeted display and promotion of information resources. On the other hand, by predicting the starting point of the public mobile device via positioning the moving public mobile device, it is possible to realize the relatively accurate judgment of the upcoming trip of the user, and to display information resources related to the upcoming trip such that the user can plan his/her activities better before he/she arrives.

### BRIEF DESCRIPTION OF THE DRAWINGS

In order to more clearly illustrate the embodiments of the present invention or the technical solutions in the prior art, the following drawings, which are to be used in the description of the embodiments or the prior art, are briefly described below.

FIG. 1 is a flow chart of an information resource pushing method, according to an embodiment of the present invention;

FIG. 2 is a flow chart of a method of returning, via a server, address information according to an information resource request received from a public mobile device, according to an embodiment of the present invention;

FIG. 3 is a structural schematic diagram for an airport handcart to achieve simultaneous advertisement broadcast, according to an embodiment of the present invention;

FIG. 4 is a flow chart of an information resource issuing method according to an embodiment of the present invention; and

FIG. 5 illustrates an example information resource system 500 according to an embodiment of the present invention.

### DETAILED DESCRIPTION

In order to clarify the objective, technical solutions and advantages of embodiments of the present invention, the technical solutions in the embodiments of the present invention will be described below in conjunction with the drawings in the embodiments of the present invention. The described embodiments may be a part of embodiments of the present invention, in some cases, rather than all the embodiments. The embodiments described herein are done so by way of example, and additional or alternative embodiments may fall within the scope of the present invention based on the teachings of the present disclosure.

Embodiments of the present invention may be applied to a variety of large public places such as airports, railway stations and ports, etc.

### Embodiment 1

An embodiment of the present invention provides an information resource pushing method applied to a server. The server may include one or more first sub-servers and one or more second sub-servers that perform various respective functions, wherein the first sub-server is configured to accept information resource requests from public mobile devices deployed in different regions and return corresponding results according to the information resource requests from the public mobile devices. The second sub-server may serve, for example, as a back-end server configured to receive an information resource issuing request from an information resource provider, and thus may be responsible for the issuance and management of information resources. The method, which may be executed by an suitable type and/or number of servers, may include the following steps S101-S105, for example, as further described below.

In step S101, the server may receive an information resource issuing request from one or more information resource providers. The information resource issuing request may include any suitable number N of issuing regions, information content IDs, an issuing destination, and/or an issuing time period related to respective information content IDs, with N being a positive integer.

In the present embodiment, the second sub-server (e.g., a back-end server) may receive the information resource issuing request from an information resource provider, and issue information resources from the information resource provider according to their issuing requests via, for example, a resource management system. The information resource issuing request may include, for example, at least one issuing region (e.g., an issuing airport or an issuing station), an information content ID, an issuing destination, and/or an issuing time period related to the information content ID. For instance, the issuing region may refer to a position where the information is issued, such as Baiyun Airport in Guangzhou, Pudong Airport, Los Angeles Airport, Narita Airport, etc. The issuing destination may be, for instance, a condition for information issuance, such as New York. For example, the condition may be within waiting periods at boarding gates for flights to New York from Baiyun Airport, from Pudong Airport, from Los Angeles Airport, from Narita Airport, etc. The issuing time period may refer, for example, to an issuing period of the local time in the issuing region. To provide some illustrative examples, the issuing time period may be 6:00 AM-12:00 AM, 6:00 PM-10:00 PM, etc. Additionally or alternatively, the information resource issuing request may include an information name, an information duration, an information resource agent name, an information resource provider name, an information issuing time, information resources, an information status, etc. The information status may include, for instance, pending review, under review, disapproved, to-be-online, online, due offline, temporarily offline, etc.

In step S102, the server may generate any suitable number N of information resource issuing tables, which correspond to N issuing regions, according to the received information resource issuing request. Each of the information resource issuing table may include, for instance, the information content IDs, the issuing destination, and/or the issuing time period related to respective information content IDs.

In the present embodiment, the second sub-servers (e.g., the back-end servers) may be classified into central resource servers and regional resource servers (e.g., airport resource servers) by function, in which the regional resource server can be logically divided into one or more servers. The central resource server may check issued information resources provided by the information resource provider. This may include, for instance, checking whether the information resource involves illegal content (e.g., containing state secrets, eroticism, violence, etc.), and issue information resource data (including resource files) to the corresponding regional resource server after the review is passed. The regional resource server may generate a corresponding information resource issuing table according to the issuing region. The information resource issuing table includes an information content ID, an issuing destination, and/or an issuing time period related to the information content ID, and may further include information items such as issuing time, information duration, information status, etc.

In step S103, the server may transmit any suitable number N of pieces of information resource issuing tables to public mobile devices in corresponding issuing regions.

In the present embodiment, information resource issuing table may be set according to the issuing regions; namely, one issuing region may correspond to one information resource issuing table. The public mobile device of each region may store the information resource issuing table issued by the regional resource server in a local built-in storage space or any suitable storage location.

In an alternative embodiment, the regional resource server may also cache resource files of the information content on a public mobile terminal in the corresponding region to enhance the display efficiency of information resources, to avoid requesting resource files (pictures, video, etc.) of information content from the regional resource server according to the information content ID at each display, thereby resulting in a large number of bandwidth occupancy.

In Step S104, the server may acquire information on the i-th issuing region and information on a known starting point adjacent to the location of the public mobile device according to the information resource request received from the public mobile device in the i-th issuing region. Furthermore, the server may determine address information of at least one node in at least one trip starting from the known starting point in the i-th issuing region, with i being a positive integer larger than 0 and smaller than or equal to N.

In the present embodiment, the first sub-server may be responsible for receiving an information resource request from the public mobile device. The nodes in a trip may refer to all stopover airports and destinations. The address information may include, for example, destination and stop address information for all trips starting from the known starting point. The i-th issuing region may refer to any region issuing information resource.

In step S105, the server may return the determined address information of the at least one node in the at least one trip to the public mobile device in the i-th issuing region for the public mobile device in the i-th issuing region to screen out an issuing destination matched with the address information from the information resource issuing table issued by the server. The server may further acquire the corresponding information content according to the screened issuing destination, and on the basis of the related information content ID, and display the information content within the corresponding issuing time period.

In the present embodiment, the public mobile device in the i-th issuing region may receive the destination and stop address information of all the trips starting from the known starting point returned by the first sub-server. The issuing destination matched with the address information may then be screened out from a locally stored information resource issuing table issued by the local server according to the destination and stopover address information. The information content ID may be further determined according to the screened issuing destination. The corresponding information content may then be acquired according to the related information content ID and displayed within the corresponding issuing time period.

In an alternative embodiment of the present invention, the method further comprises the following steps.

When monitoring one or more additional issuing regions existing in the information resource issuing request from at least one information resource provider, the central resource server may issue changed information content (including resource files) to the corresponding regional resource server according to a received changed advertisement issuing request. The regional resource server may then generate each corresponding information resource issuing table with respect to the at least one added issuing region.

The regional resource server may send respective information resource issuing tables to a public mobile device in at least one of the related issuing regions. Additionally or alternatively, when monitoring a deletion of one or more issuing regions existing in the information resource issuing request from at least one information resource provider, the central resource server may send an instruction to delete the information content (including resource files) to the regional resource server in the at least one deleted region. Moreover, the regional resource server may send an instruction to delete the information resource issuing table to the public mobile device in at least one deleted region.

In another alternative embodiment of the present invention, the method further comprises the following steps.

When monitoring a change of an issuing destination existing in the information resource issuing request from at least one information resource provider, the central resource server may issue the changed information content data (including resource files) to the corresponding regional resource server according to a received changed advertisement issuing request. The regional resource server may generate each changed information resource issuing table corresponding to each issuing region according to the received information resource issuing request based on the change of the issuing destination.

The regional resource server may send each changed information resource issuing table to the public mobile device in each related issuing region.

It should be noted that changes in the information issuing request may also include changes in the review status of information, issuing status of information, a duration of information, an issuing time period, information resource files, etc. In this way, each time the information changes (e.g., changes in review status, issuing status, issuing region, issuing destination, issuing time period, information duration, information resources and other information, etc.), the server may repeat the re-review process, and issue the information resource issuing table to the public mobile device in each region. In this way, it is ensured that the information content of the server (including the central resource server and the regional resource server), and the information content of the public mobile device in each issuing region, are kept in sync with one another.

In an alternative embodiment of the present invention, the method further comprises the following steps:

When returning the determined address information of the at least one node in the at least one trip to the public mobile device in the i-th issuing region, the server may further return a synchronous control instruction to the public mobile device in the i-th issuing region, which may include a current playing location (index) and an elapsed playing time S, with the synchronous control instruction being generated according to the following steps:

determining a corresponding information content sequence according to the determined address information of the at least node in the at least one trip, the information content sequence including each piece of information content ID and a time length of each piece of information content;

calculating a total time length M of the information content sequence within a single cycle;

determining a number of cycles of the played information content sequence corresponding to the current system time and a time length L of the played information content in the currently played information content sequence, according to a time length K corresponding to the current system time and the total time length M of the information content sequence within the single cycle;

determining the current playing location index and the elapsed playing time S according to a sequentially accumulative comparison of the determined time length L of the played information content in the currently played information content sequence and the time length of each piece of information content in the information content sequence; and

sending the current playing location index and the elapsed playing time S to the public mobile device in the i-th issuing region.

In the present embodiment, a synchronous control instruction generation algorithm is embodied as follows:

First, it is assumed that the information content sequence includes n (n>=1) pieces of information content, and denoting the time length of each piece of information content as T1, T2 . . . Tn respectively. The total time length M may be calculated of the information content sequence within the single cycle, where M=ΣTₖ, and k=1, 2, . . . , n.

A number of cycles of the played information content sequence may be determined corresponding to the current system time and a time length L of the played information content in the currently played information content sequence, according to a time length K corresponding to the current system time and the total time length M of the information content sequence within the single cycle, where L=K%M, and % is an modulus operator for taking a remainder.

The current playing location index and the elapsed playing time S may be determined via the following formula:

$$L - {\sum }_{i = 1}^{k - 1} {T}_{i} <= {{T}_{k}}_{⋁ ⋁ ⋁}$$

according to the determined time length L of the played information content in the currently played information content sequence and the time length of each piece of information content.

Where

$$L - {\sum }_{i = 1}^{k - 1} {T}_{i} = {{T}_{k}}_{⋁ ⋁ ⋁} , S = 0 , \{ \begin{matrix}index = k + 1 , k < n \\ index = 1 , k = n \end{matrix} ;$$

Where

$$L - {\sum }_{i = 1}^{k - 1} {T}_{i} <= {{T}_{k}}_{⋁ ⋁ ⋁} ,$$

S=L, index=k;

thereby obtaining the current playing location index and the elapsed playing time S.

In the present embodiment, the time length of each piece of information content, the total time length M of the information content sequence within the single cycle, the time length L of the played information content in the currently played information content sequence, the elapsed playing time S, and the time length K corresponding to the current system time are in seconds.

The time length K (corresponding to the current system time) may be determined according to a difference between a certain reference time point and the current system time. For example, the reference time point may be selected as 00:00:00 of the current day, or also as 00:00:00 of the previous day. To provide an illustrative example, when the reference time point is 00:00:00 of the current day, and the current system time is 14:20:15, then K=14*3,600+20*60+15=3025215 seconds. To provide another illustrative example, when the reference time point is 00:00:00 of the previous day, K=(24+14)*3,600+20*60+15=8,209,125 seconds.

In an embodiment, determining the corresponding information content according to the determined address information of at least one node of the at least one trip may include:

selecting address information of the nodes of all the trips corresponding to the known starting point adjacent to the location of the public mobile device in the i-th issuing region on the current day; screening out an issuing destination matched with the obtained address information from the information resource issuing table corresponding to the i-th issuing region, and inquiring an ID and a time length of related information content including the current system time within the issuing time period of the information content from the information resource issuing table according to the issuing destination.

Screen synchronization of public mobile devices under the same environment may be achieved via synchronous control over information resources. As such, the user may be exposed repeatedly to displayed information via screen synchronization, hence enhancing his memory of the information, which is more conducive to achieve the effect of information resource publicity.

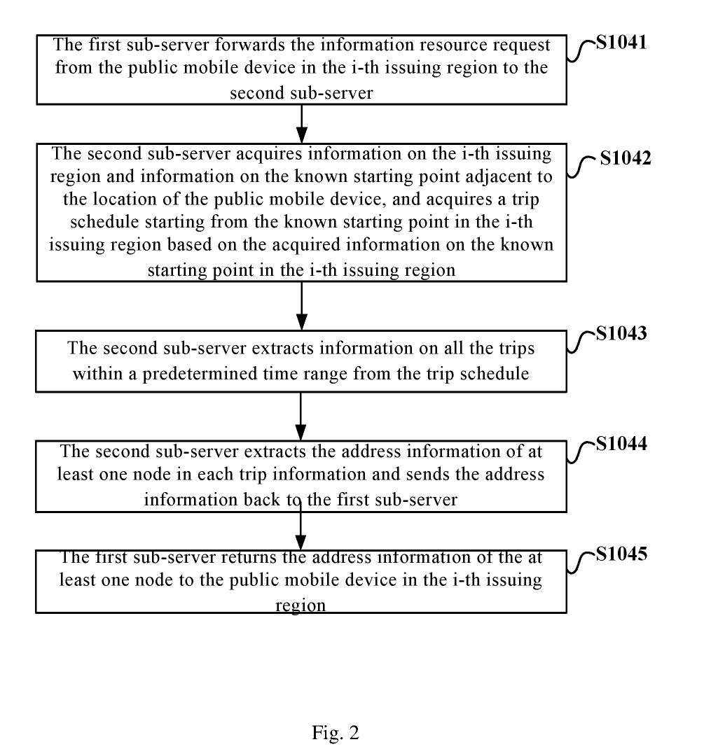

In an alternative embodiment, referring to FIG. 2, the step S104 may include the following steps S1041-S1045.

In step S1041, the first sub-server may forward the information resource request from the public mobile device in the i-th issuing region to the second sub-server.

In step S1042, the second sub-server may acquire information on the i-th issuing region and information on the known starting point adjacent to the location of the public mobile device, and may acquire a trip schedule starting from the known starting point in the i-th issuing region based on the acquired information on the known starting point in the i-th issuing region.

In step S1043, the second sub-server may extract information on all the trips within a predetermined time range from the trip schedule.

In the present embodiment, the predetermined time range may be configured in any suitable manner, such as, for example, 00:00:00 to 23:59:59 on the current day (i.e., a certain day). With respect to a delayed trip in the trip schedule, if an estimated departure time of this trip has been allocated (and the value of this field is non-empty), the original estimated departure time of the trip is calculated. If the estimated departure time of the trip involves no trip information within a predetermined time range, then the trip information in which the estimated departure time is closest to the end time of the predetermined time range may be selected from the trip schedule.

In step S1044, the second sub-server may extract the address information of at least one node in each piece of trip information, and send the address information back to the first sub-server.

In step S1045, the first sub-server may return the address information of the at least one node to the public mobile device in the i-th issuing region.

In the present embodiment, each time the status of the trip changes (e.g., a departure point change, a cancellation or end, etc.), the second sub-server may repeat the above-described step S1042 to step S1044 to push (PUSH) the corresponding information to each of the public mobile devices near the known starting point in the i-th issuing region. Thus, the information regarding the known starting point in the i-th issuing region is no longer pushed for the public mobile device (i.e., when the reported location information of the public mobile device changes) that is away from the known starting point in the i-th issuing region. In some scenarios, this step may also be achieved by pulling (i. e, PULL). That is, the public mobile device in the i-th issuing region may actively transmit or otherwise report the location information in accordance with a particular schedule (e.g. every 120 seconds). After receiving the information, the second sub-server may repeat the above-described steps S1042 to S1044 and return the corresponding information to the public mobile device.

### Embodiment 2

The embodiment of the present invention may include a non-volatile computer storage medium for storing computer executable programs therein, the computer executable programs being used to execute the information resource pushing method in any of method embodiments described above.

As an implementation, the non-volatile computer storage medium of the present invention may be configured to store computer executable programs, the computer executable programs being configured to execute one or more of the following:

receiving an information resource issuing request from an information resource provider, the information resource issuing request including at least one issuing region, each piece of information content ID, an issuing destination, and/or an issuing time period related to the information content ID;

generating an information resource issuing table corresponding to each issuing region according to the received information resource issuing request, the information resource issuing table including the information content ID, the issuing destination, and/or the issuing time period related to the information content ID;

sending the information resource issuing table to a public mobile device in a corresponding issuing region;

acquiring information on the i-th issuing region and information on a known starting point adjacent to the location of the public mobile device according to the information resource request received from the public mobile device in the i-th issuing region, and determining address information of at least one node in at least one trip starting from the known starting point in the i-th issuing region;

returning the determined address information of the at least one node in the at least one trip to the public mobile device in the i-th issuing region for the public mobile device in the i-th issuing region to screen out an issuing destination matched with the address information from the information resource issuing table issued by the server, and further acquiring the corresponding information content according to the screened issuing destination and on the basis of the information content ID, and displaying the information content within the corresponding issuing time period.

As a non-volatile computer-readable storage medium, the nonvolatile computer storage medium may be used to store software programs, computer executable programs and modules, etc. For instance, the nonvolatile computer storage medium may store program instructions/modules corresponding to the information resource pushing method for the public mobile devices in the embodiment of the present invention. The one or more modules may be stored in the non-volatile computer readable storage medium and, when executed by a processor, configured to perform various acts, such as one or more methods in any of the method embodiments described herein.

The non-volatile computer-readable storage medium may include a program storage area and a data storage area, wherein the program storage area may be configured to store applications required for at least one function of an operating system. The data storage area may be configured to store data created according to information resource pushing. In addition, the non-volatile computer-readable storage medium may include a high-speed random access memory and a non-volatile memory, such as at least one disk storage device, flash memory device, or other non-volatile solid state memory device. In some embodiments, the non-volatile computer-readable storage medium may optionally include memories remotely provided with respect to the processor, and these remote memories may be connected over a network to an information resource pushing system. Examples of the network may include, but are not limited to, the Internet, an intranet, a local area network, a mobile communication network, combinations thereof, etc.

### Embodiment 3

The embodiment of the present invention includes a server, which may include one or more of:

one or more processors;

a wireless communication device configured to communicate with a public mobile device; and

a memory configured to store programs executable by the one or more processors, the programs being executed by the one or more processors such that the one or more processors are capable of executing one or more of the following steps:

receiving, via the server, an information resource issuing request from an information resource provider, the information resource issuing request including N issuing regions, information content IDs, issuing destination, and/or issuing time period related to respective information content IDs;

generating, via the server, N information resource issuing tables corresponding to N issuing regions according to the received information resource issuing request, the information resource issuing table including the information content ID, the issuing destination, and/or the issuing time period related to the information content ID;

sending, via the server, the N information resource issuing tables to a public mobile device in corresponding N issuing regions;

acquiring, via the server, information on the i-th issuing region and information on a known starting point adjacent to the location of the public mobile device according to the information resource request received from the public mobile device in the i-th issuing region, and determining, via the server, address information of the at least one node in the at least one trip starting from the known starting point in the i-th issuing region;

returning, via the server, the determined address information of the at least one node in the at least one trip to the public mobile device in the i-th issuing region for the public mobile device in the i-th issuing region to screen out an issuing destination matched with the address information from the information resource issuing table issued by the server, and further acquiring, via the server, the corresponding information content according to the screened issuing destination and on the basis of the information content ID, and displaying the information content within the corresponding issuing time period.

Via the server described herein, the centralized and unified management of information resources that need to be displayed in different public places is thus achieved. Moreover, the display validity, accuracy, and uniformity of information resources on public mobile devices in different regions are ensured by interacting with public mobile terminals in different regions. In this way, the problems described herein regarding the existing display of information resources being restrained by property rights, operation rights, and management rights of information display in public places are overcome. Further, unified networking display of information resources in multiple public places among a number of places around the world (for example, the whole city, the whole province, the whole country, the whole world) is thereby achieved.

### Embodiment 4

The embodiment of the present invention provides an information resource system comprising the server as described herein (e.g., in the above embodiment), and public mobile devices capable of being deployed in different regions. These different regions may include, for instance, different positions in different countries and areas. For example, the public mobile devices may be deployed in different positions in Beijing Airport, or may be deployed in different positions in New York Airport.

In one embodiment of the present invention, the public mobile device may include one or more of:

one or more processors;

a wireless communication device configured to communicate with the server;

a display; and

a memory configured to store programs executable by the one or more processors, the programs being executed by the one or more processors such that the one or more processors may be configured to execute one or more acts, including, for example:

receiving an information resource issuing table issued by the server according to an i-th issuing region of any suitable number of N issuing regions, the information resource issuing table at least including: information content IDs, an issuing destination, and/or an issuing time period related to respective information content IDs, with N being a positive integer, and i being a positive integer larger than 0 and less than or equal to N;

detecting first location information in which the public mobile device is located;

when a distance between the first location information and second location information of a known starting point in the i-th issuing region is less than a predetermined distance threshold, counting a duration of time in which the public mobile device resided within a range (e.g., a radius) of the predetermined distance threshold from the starting point;

when the duration of time reaches a predetermined time threshold, sending, to the server, an information resource request for requesting address information of at least one node in at least one trip starting from the starting point, the information resource request including information on the i-th issuing region and/or the information on the starting point;

screening out an issuing destination matched with the address information from the information resource issuing table according to the address information returned by the server;

acquiring the corresponding information content according to the related information content ID according to the screened issuing destination, and displaying the information content within the corresponding issuing time period.

In another alternative embodiment of the present invention, the at least one display of the public mobile device may include a public electronic display screen having a projection angle that faces an external public visual field.

### Embodiment 5

According to an embodiment of the present invention, an information resource issuing method for the information resource system is provided.

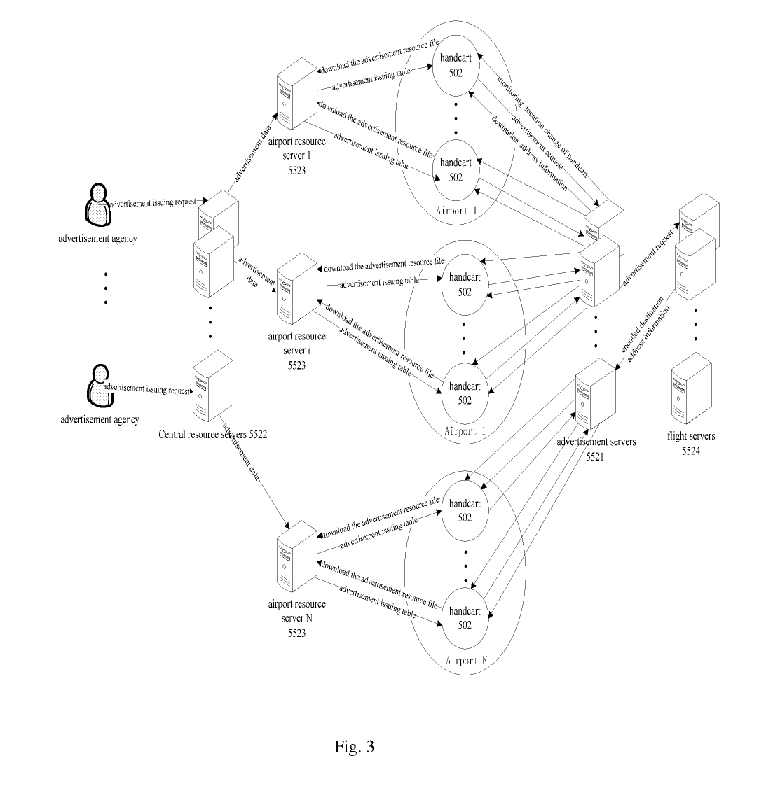

A handcart 502 is taken as an example of the public mobile device, advertisements are taken as an example of information resources, and an airport is taken as an example of an information resource issuing region. FIG. 3 is a structural schematic diagram for an airport handcart 502 to achieve simultaneous advertisement broadcasts. The server 552 may be implemented, for instance, as one or more advertisement servers 5521 as first servers and one or more back-end servers as second servers. The back-end servers may be used, for example, for the management of advertisement and flight information, which can be classified into central resource servers 5522, airport resource servers 5523, and flight servers 5524 by function, with the central resource servers 5522 and the airport resource servers 5523 being responsible for the maintenance and management of the advertisement data. The advertisement server 5521 may be used, for example, for monitoring the location change of the handcart 502, which may be detected by a single-chip processor mounted in or otherwise associated with the handcart 502, receiving an advertisement request from the handcart 502, and returning the corresponding result according to the request.

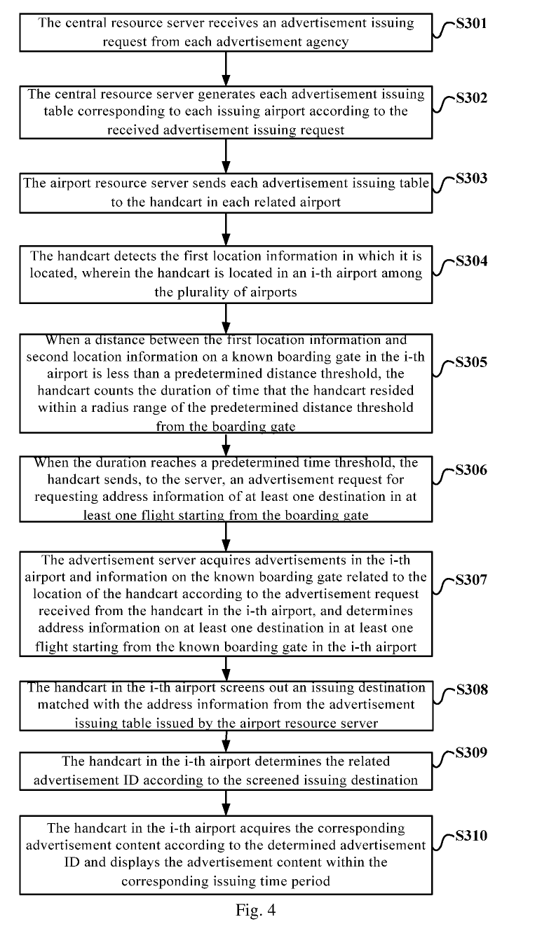

FIG. 4 is a flow chart of an information resource issuing method for an information resource system according to an embodiment of the present invention. The method may comprise the following steps S301-S310.

In step S301, the central resource server may receive an advertisement issuing request from each advertisement agency, wherein the advertisement issuing request includes an issuing region (such as an issuing airport), each advertisement ID, an issuing destination, and/or an issuing time period related to each advertisement ID.

In the present embodiment, with respect to the server (in particular, the central resource server in the back-end servers), the server may receive the advertisement issuing request from each advertisement agency, and issue advertisement information of the agency according to its issuing request, which may be done, for example, via a resource management system. The advertisement issuing request may include, for instance, an issuing region (an issuing airport), each advertisement ID, an issuing destination, and/or an issuing time period related to each advertisement ID, etc. In addition, the advertisement issuing request may include, for example, an advertisement name, an advertisement duration, an advertisement agency name, an advertiser name, an advertisement issuing time, an advertisement resources, an advertisement status, etc. The advertisement status may include, for example, pending review, under review, disapproved, to-be-online, online, due offline, temporarily offline, etc.

In step S302, the airport resource server may generate an advertisement issuing table corresponding to each issuing airport, with each advertisement issuing table including each advertisement ID, an issuing destination, and/or an issuing time period related to each advertisement ID.

In the present embodiment, with respect to the server, specifically, the central resource server in the back-end servers may review the issued information resources provided by the information resource provider, and issue advertisement data (including resource files) to the corresponding airport resource server corresponding to each airport after the review has been passed. The airport resource server may generate the corresponding advertisement issuing tables according to the different airports. The advertisement resource issuing table may include an advertisement content ID, an issuing destination, and/or an issuing time period related to the advertisement ID, and may further include information items such as issuing time, advertisement duration, advertisement status, etc.

In step S303, the airport resource server may send each advertisement issuing table to the handcart in each related airport.

In the present embodiment, with respect to the server, specifically, the airport resource server in the back-end servers may issue the advertisement issuing table to the handcart in each corresponding airport, and the handcart may store the advertisement issuing table issued by the airport resource server in a local built-in storage space.

In step S304, the handcart may detect the first location information in which it is located, with the handcart being located in the i-th airport among the plurality of airports.

In the present embodiment, the first location information of the handcart may be acquired via any suitable number and/or type of indoor and/or outdoor positioning techniques. For example, in the indoor environment of the airport, the positioning of the handcart may be achieved using a variety of indoor technologies based on indoor map information inside the airport.

In Step S305, when a distance between the first location information and second location information on a known boarding gate in the i-th airport is less than a predetermined distance threshold, the handcart may count a duration of time that the handcart resided within a range (e.g., a radius) of the predetermined distance threshold from the boarding gate.

In the present embodiment, the second location information on the known boarding gate can be stored in advance in a map database of the handcart for calling use. In an embodiment, the predetermined distance threshold may be a configurable distance value that is less than a half of a minimum value of the distance between any two adjacent known boarding gates. For example, if the distance between two adjacent known boarding gates is 200 meters, the predetermined distance threshold should be less than 100 meters.

In step S306, when the duration reaches a predetermined time threshold, the handcart may send, to the server, an advertisement request for requesting address information of at least one destination in at least one flight starting from the boarding gate, the advertisement request including information on the i-th airport and/or information on the boarding gate.

In the present embodiment, the i-th airport may be any region of advertisement issuance, i.e., any one of airports. The predetermined time threshold may be a configurable time length value such as 10 minutes.

In step S307, the advertisement server may acquire advertisements in the i-th airport and information on the known boarding gate related to the location of the handcart according to the advertisement request received from the handcart in the i-th airport, and may determine address information on at least one destination in at least one flight starting from the known boarding gate in the i-th airport.

In the present embodiment, the advertisement server (e.g., the first sub-server) may be configured to receive the advertisement request from the handcart. The destination addresses may include the destination and stop addresses of the flights starting from the boarding gate.

In an alternative embodiment of the present invention, the step S307 may be performed according to the following steps S3071-S3075.

In step S3071, the advertisement server may forward the information resource request from the handcart in the i-th airport to a flight server.

In step S3072, the flight server may acquire the information on the i-th airport and the information on a known boarding gate related to the location of the handcart, and acquires a schedule of all the flights starting from the known boarding gate in the i-th airport according to the acquired information on the known boarding gate in the i-th airport.

In step S3073, the flight server may extract information on all the flights within a predetermined time range from the flight schedule.

In the present embodiment, the predetermined time range may be a configurable time range, such as the current day. To provide an illustrative example, the start time of the time range may be 00:00:00 on one day, with the end time being 23:59:59 on that day. The flight server may obtain all the flights in which the estimated departure time (or estimated boarding time) is within the predetermined time range according to estimated departure time (or estimated boarding time) fields of the flights.

In step S3074, the flight server may extract the address information of at least one destination of each flight according to the flight information, encode the address information of the destination, and send the encoded address information back to the advertisement server.

In the present embodiment, the flight server may extract and save a three-letter code of the destination airport corresponding to each flight according to the flight. If the flight is a multi-segment flight, the flight server may extract and save three-letter codes of stop airports of this flight at the same time.

If the inquiry result involves no flight within a predetermined time range (for example, the current day), embodiments include selecting a flight in which the estimated departure time (or estimated boarding time) is closest to the end time of the predetermined time range from the flight schedule, and extracting and saving a three-letter code of the destination airport and a three-letter code of the stop airport corresponding to this flight. If there is no stop, then the three-letter code of a stop airport may not be extracted.

With respect to a flight having a delayed status in the flight schedule, if the estimated departure time (or estimated boarding time) of the flight has been allocated (and the value of this field is non-empty), embodiments include calculating a flight in which the original estimated departure time (or original estimated boarding time) is within a predetermined time range (for example, the current day), and extracting and saving a three-letter code of a destination airport and a three-letter code of a stop airport corresponding to this flight. If there is no stop, a three-letter code of a stop airport may not be extracted.

In step S3075, the advertisement server may inquire the corresponding address information according to the received address information codes of the destination, and return the address information to the handcart in the i-th airport.

In the present embodiment, the advertisement server in this inquiry may inquire information on corresponding city and province from all the saved three-letter codes of destination airports (stops also belong to the destinations) by requesting a general administrative division table, and return the destination city and province names to the handcart. The general administrative division table is used to maintain the global airports and corresponding geographic information thereof. In China, for example, the administrative division table used in the system has a formula structure: the country (China)—provinces (for example: Jiangsu Province)—cities (for example: Nanjing)—Airport (for example: Lukou Airport, Three-letter Code: NKG).

In step S308, the handcart in the i-th airport may screen out an issuing destination matched with the address information from the advertisement issuing table issued by the airport resource server.

In the present embodiment, the handcart may screen out the issuing destination matched with the address information from the advertisement issuing table issued by the airport resource server according to the address information returned by the advertisement server. An updated advertisement issuing table may also be issued to the handcart at any time if it is updated.

In step S309, the handcart in the i-th airport determines the related advertisement ID according to the screened issuing destination.

In step S310, the handcart in the i-th airport may acquire the corresponding advertisement content according to the determined advertisement ID and display the advertisement content within the corresponding issuing time period.

In the present embodiment, the handcart in the i-th airport preferentially searches for the corresponding advertisement resource file from the locally stored built-in storage space, respectively, according to the advertisement ID. If there is no advertisement resource file in the local built-in storage space, the airport resource server may be requested to download the advertisement resource file.

After the handcart retrieves all the advertisement IDs and advertisement resource files, embodiments include determining the playing progress according to the issuing time period corresponding to the advertisement ID and the synchronous control instruction issued by the server, and playing advertisements according to the current playing progress and the playing rules.

During the process of advertisement play, if the handcart exits the current boarding gate, and enters into a new location and stays for the specified time, the above steps S304 to S310 may be repeated.

During the process of advertisement play, if the same flight has sent changes in the following status (e.g., boarding gate change, cancellation, boarding end, takeoff, etc.) at the boarding gate in the flight schedule within the predetermined time range (e.g., the current day), the advertisements corresponding to the destination corresponding to the flight may be removed from the loop sequence. The flight schedule within a predetermined time range (e.g., the current day) is identified again, and a new advertisement playing sequence is determined in sequence.

When the handcart is located near the designated boarding gate, the flight information corresponding to the boarding gate may also be displayed on a terminal screen of the handcart after each play of five advertisements during the advertisement playing process. The flight information may be displayed identical to data displayed on a flight display screen (a flight information display screen) near the boarding gate. After some threshold time duration passes (e.g., 30 seconds of display), the advertisements may be continually played.

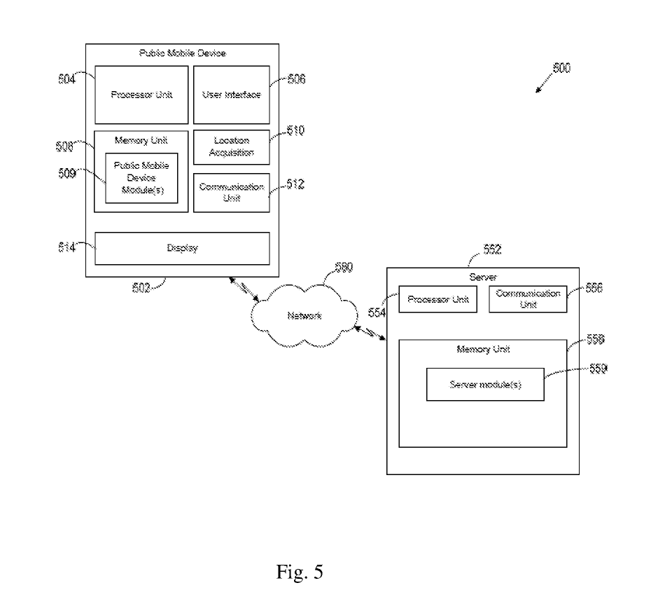

FIG. 5 illustrates an example information resource system 500 according to an embodiment of the present invention. Information resource system 500 may include any suitable number of public mobile devices 502, servers 552, and/or communication networks 580, although only single components are shown in FIG. 5 for purposes of brevity.

One or more public mobile devices 502 may communicate with one another or via a server 552, and may do so directly or indirectly (e.g., via communication network 580). Thus, communication network 580 may include any suitable combination of wired and/or wireless communication networks, nodes, links, etc. For example, communication network 580 may include any combination of a local area network (LAN), a metropolitan area network (MAN), a wide area network (WAN), etc., and may facilitate a connection to the Internet. To provide further examples, communication network 580 may include wired telephone and cable hardware, satellite, cellular phone communication networks, etc.

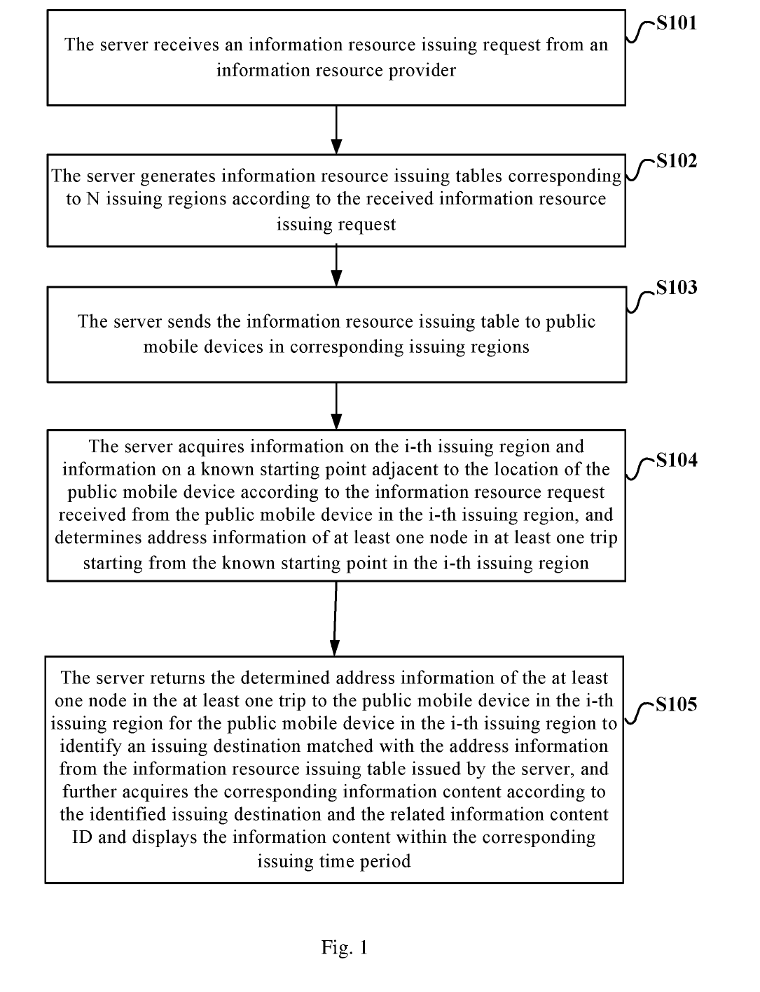

Public mobile device 502 may include any suitable combination of software and/or hardware to facilitate the various embodiments described herein, such as the various methods as discussed with reference to FIGS. 1-4, for example. In various embodiments, public mobile device 502 may include lesser, greater, or alternative components to carry out such functions. For instance, the public mobile device 502 may include a processor unit 504, a user interface 506, a memory unit 508, a location acquisition unit 510, a communication unit 512, and a display 514, which may be interconnected and/or otherwise coupled to one another in any suitable manner to facilitate communication between these various components. In various embodiments, public mobile device 502 may be implemented as any suitable type of computing device configured to receive and/or send data transmissions and to present information in accordance with the embodiments described herein. For example, the public mobile device 502 may be implemented as an airport handcart or other user equipment (UE) such as a mobile device, a computer, laptop, tablet, desktop, or any other suitable type of computing device.

User interface 506 may be configured to allow a user to interact with the public mobile device 502. For example, user interface 506 may include a user-input device such as an interactive portion of display 514 (e.g., a “soft” keyboard displayed on display 514), an external hardware keyboard configured to communicate with public mobile device 502 via a wired or a wireless connection (e.g., a Bluetooth keyboard), an external mouse, or any other suitable user-input device.

Location acquisition unit 510 may be configured to obtain location data corresponding to a location of public mobile device 502. Thus, location acquisition unit 510 may be implemented using any combination of suitable hardware and/or software to determine this location data, which may be performed in accordance with any suitable type of indoor and/or outdoor positioning techniques. For example, location acquisition unit 510 may be implemented as a global navigation satellite system (GNSS) receiver configured to determine latitude and longitude coordinates via GNSS satellite communications using any suitable GNSS frequency or one or more bands of GNSS frequencies. To provide another example, location acquisition unit 510 may be implemented in accordance with an indoor position location system that leverages communications with other devices (not shown) that are located at known locations within a mapped area (e.g., an airport).

Alternatively or additionally, various embodiments of location acquisition unit 510 include obtaining location information via one or more triangulation and/or network localization techniques. For example, location acquisition unit 510 may be configured to utilize wireless communications via communication unit 512 to determine a location of public mobile device 502 by calculating its location based on signal strength measurements of one or more base stations, access points, etc., within range of communication unit 512. These base stations and access points could include, for example, cellular base stations, local WAN access points, etc. In an embodiment, location acquisition unit 510 may be configured to determine location data and to send this location data to the server 552.

Communication unit 512 may be configured to enable data communications between one or more public mobile device 502 and/or one or more servers 552 via communication network 580. In an embodiment, communication unit 512 may be configured to transmit data, such as information requests and/or other data used in accordance with the embodiments described herein, to one or more servers 552. Further in accordance with various embodiments, communication unit 512 may be configured to receive data, such as information issuing tables and/or other data used in accordance with the embodiments described herein, from one or more servers 552.

Communication unit 512 may be implemented with any suitable combination of hardware and/or software to enable these functions. For example, communication unit 512 may be implemented with any suitable number of wired and/or wireless transceivers, network interfaces, physical layers (PHY), etc. For example, communication unit 512 may enable communications with one or more networks or devices, which may or may not be part of communication network 580. For example, communication unit 512 may be configured to communicate with cellular and/or WLAN networks in addition to communication network 580. Networks separate from communication network 580 are not shown in FIG. 5 for purposes of brevity.

In various embodiments, communication unit 512 may be configured to measure the strength of signals received from other communication devices within range and to provide these measurements to location acquisition unit 510. For example, communication unit 512 may be configured to measure the signal strength of signals received from one or more base stations. Alternatively or additionally, communication unit 512 may be configured to measure the signal strengths of signals received from one or more access points. In this way, communication unit 512 may provide location acquisition unit 510 with an additional or alternate way of determining location data. Such embodiments might be particularly useful when, for example, a GNSS satellite signal is unavailable.

Display 514 may be implemented as any suitable type of display that may facilitate user interaction, such as a capacitive touch screen display, a resistive touch screen display, etc. In various aspects, display 514 may be configured to work in conjunction with user-interface 506 and/or processor unit 504 to detect user inputs upon a user selecting a displayed interactive icon or other graphic, to identify user selections of objects displayed via display 514, etc. Moreover, the display 514 may be configured to present information to the user, as described herein in accordance with the embodiments discussed above with reference to FIGS. 1-4.

In various embodiments, processor unit 504 may be implemented as any suitable number and/or type of processors, such as a host processor for the relevant device in which public mobile device 502 is implemented, for example. Processor unit 504 may be configured to communicate with one or more other components of public mobile device 502, to send data to and/or to receive data from one or more of these components, and/or to store data to and/or to read data from one or more of these components, such as memory unit 508, for example.

In accordance with various embodiments, memory unit 508 may be a computer-readable non-transitory storage device that may include any combination of volatile (e.g., a random access memory (RAM), or a non-volatile memory (e.g., battery-backed RAM, FLASH, etc.). Memory unit 508 may be configured to store instructions executable on processor unit 504 to carry out various functions. These instructions may be represented, for instance, as machine readable instructions illustrated as one or more public mobile device modules 509 such that, when executed by processor unit 504, cause the public mobile device 502 to perform these functions. These functions may be, for instance, those associated with the embodiments discussed herein, such as the embodiments described with reference to FIGS. 1-4.

Server 552 may include any suitable combination of software and/or hardware to facilitate the various embodiments described herein, such as the various methods as discussed with reference to FIGS. 1-4, for example. In various embodiments, server 552 may include lesser, greater, or alternative components to carry out such functions. Server 552 may be implemented as any suitable number and/or type of computer server devices, which may be configured to communicate with one another directly or indirectly (e.g., via communication network 580). For example, server 552 may be implemented as one or more web servers, network servers, database servers, etc. Additionally, server 552 may be configured to communicate with one or more information resource providers directly or indirectly, as discussed herein.

For instance, server 552 may include the first and second sub-servers discussed above. Thus, the server 552 may accept information resource requests from public mobile devices 502 deployed in different regions, and return corresponding results according to these information resource requests. Moreover, server 552 may serve (or have one or more components that serve), for example, as a back-end server configured to receive information resource issuing requests from an information resource provider, and thus may be responsible for the issuance and management of information resources.

To facilitate this functionality, server 552 may include a processor unit 554, a communication unit 556, and a memory unit 558, which may be interconnected and/or otherwise coupled to one another in any suitable manner to facilitate communication between these various components.

Communication unit 556 may be configured to enable data communications between one or more servers 552 and public mobile device 502 via communication network 580. In an embodiment, communication unit 556 may be configured to transmit data, such as information issuing tables and/or other data used in accordance with the embodiments described herein, to one or more public mobile devices 502. Further in accordance with various embodiments, communication unit 556 may be configured to receive data, such as information requests and/or other data used in accordance with the embodiments described herein, from one or more public mobile devices 502.

Communication unit 556 may be implemented with any suitable combination of hardware and/or software to enable these functions. For example, communication unit 556 may be implemented with any number of wired and/or wireless transceivers, network interfaces, physical layers (PHY), etc. For example, communication unit 556 may enable communications with one or more networks, servers, or devices, which may or may not be part of communication network 580.

In various embodiments, processor unit 554 may be implemented as any suitable number and/or type of processors, such as a host processor for the relevant device in which server 552 is implemented, for example. Processor unit 554 may be configured to communicate with one or more other components of serer 552, to send data to and/or to receive data from one or more of these components, and/or to store data to and/or to read data from one or more of these components, such as memory unit 558, for example.

In accordance with various embodiments, memory unit 558 may be a computer-readable non-transitory storage device that may include any combination of volatile (e.g., a random access memory (RAM), or a non-volatile memory (e.g., battery-backed RAM, FLASH, etc.). Memory unit 558 may be configured to store instructions executable on processor unit 554 to carry out various functions. These instructions may be represented, for instance, as machine readable instructions illustrated as one or more server device modules 559 such that, when executed by processor unit 554, cause the server 552 to perform various functions. These various functions may be, for instance, those associated with the embodiments described herein, such as the embodiments described with reference to FIGS. 1-4.

### Technical Advantages

With the system provided by the present invention, the management and display of information resources are well integrated with the public mobile devices, and may not be restrained by sites and fixed display devices through movement of the public mobile devices. Thus, it is a good solution to the problems described herein that the existing display of information resources is restrained by property rights, operation rights, and management rights of information display in public places. The system provided by the present invention thus makes it easier for the public mobile devices to be deployed in different areas for public use that may be delivered via hardware free of charge and/or in a low cost manner, such as in different sites in a public place, different places in a city, different cities in a country, or in countries on a global scale. Therefore, not only is the cost effectively reduced, but restrictions from the information resource display area are alleviated, thereby achieving the dissemination of information resources on a global scale.

For example, if an advertiser has advertisement resources to be issued in Shanghai, the general practice is only to perform advertisement and publicity in the issuing site of Shanghai. By adopting the embodiments described herein, it is only necessary to manage the issuance requests of the advertisers in a unified manner, and the advertisements can then be broadcasted in various public transportation places, such as various airports, stations, and wharves that can reach Shanghai, thereby achieving national or global advertisement networking effect.

Moreover, the embodiments described herein may be implemented as part of one or more computer components, such as public mobile devices and/or one or more server components. As such, the embodiments described herein may be implemented as part of a computer network architecture that facilitates communications between various other devices and/or components. Thus, the embodiments described herein address and solve issues of a technical nature that are necessarily rooted in computer technology.

In doing so, the embodiments also address issues related to processing and resource usage by servers and/or public mobile devices. For example, by offloading the task of synchronization to servers in this manner, processing resources are conserved, allowing the public mobile devices to utilize less power. As a result, the embodiments described herein also help address issues related to controlling processing resources and regulating power usage.

The foregoing embodiments of device are merely illustrative, in which those units described as separate parts may or may not be separated physically. A displaying part may or may not be a physical unit, i.e., may be locates in one place or distributed in several parts of a network. Some or all modules may be selected according to practical requirement to realize the purpose of the embodiments, and such embodiments can be understood and implemented by the skilled person in the art without inventive effort.

A person skilled in the art can clearly understand from the above description of embodiments that these embodiments can be implemented through software in conjunction with general-purpose hardware, or directly through hardware. Based on such understanding, the essence of foregoing technical solutions, or those features making contribution to the prior art may be embodied as software product stored in computer-readable medium such as ROM/RAM, diskette, optical disc, etc., and comprising instructions for execution by a computer device (such as a personal computer, a server, or a network device) to implement methods described by foregoing embodiments or a part thereof.

Finally, it should be noted that, the above embodiments are merely provided for describing the technical solutions of the present invention, but not intended as a limitation. Although the present invention has been described in detail with reference to the embodiments, those skilled in the art will appreciate that the technical solutions described in the foregoing various embodiments can still be modified, or some technical features therein can be equivalently replaced. Such modifications or replacements do not make the essence of corresponding technical solutions depart from the spirit and scope of technical solutions embodiments of the present invention.

1. An information pushing method, comprising:
receiving, via a server, an information issuing request from an information resource provider, the information issuing request comprising information content IDs of N issuing regions, an issuing destination, and an issuing time period related to respective ones of the information content IDs, wherein N is a positive integer;
generating, via the server, N information issuing tables corresponding to the N issuing regions according to the received information issuing request, the information issuing table comprising the information content ID, the issuing destination, and the issuing time period related to the information content ID;
transmitting, via the server, the N information issuing tables to a public mobile device located within the N corresponding issuing regions;
acquiring, via the server, information regarding an i-th issuing region and information regarding a known starting point adjacent to a location of the public mobile device according to the information issuing request received from the public mobile device within the i-th issuing region;
determining, via the server, address information of at least one node in at least one trip starting from the known starting point within the i-th issuing region, wherein i is a positive integer less than 0 and greater than or equal to N;
returning, via the server, the determined address information of the at least one node within the at least one trip to the public mobile device within the i-th issuing region, such that the public mobile device within the i-th issuing region identifies an issuing destination matched with the address information from the information issuing table transmitted by the server;
acquiring, via the server, the corresponding information content in accordance with (i) the identified issuing destination, and (ii) the related information content ID; and
displaying the information content within the corresponding issuing time period.

2. The method according to claim 1, further comprising:
when monitoring at least one additional issuing region existing in the information issuing request from at least one information resource provider, generating, via the server, each corresponding information issuing table with respect to the at least one additional issuing region;
transmitting, via the server, each information issuing table to a public mobile device in at least one related issuing region; and
when monitoring a deletion of at least one issuing region existing in the information issuing request from at least one information resource provider, transmitting, via the server, an instruction to delete the information issuing table to the public mobile device in the at least one deleted region.

3. The method according to claim 1, further comprising:
when monitoring a change of an issuing destination in the information issuing request from at least one information resource provider, generating, via the server, each changed information issuing table corresponding to each issuing region according to the received information issuing request based on the change of the issuing destination; and
transmitting, via the server, each changed information issuing table to a public mobile device in each respective issuing region.

4. The method according to claim 1, further comprising:
when returning, via the server, the determined address information of the at least one node in the at least one trip to the public mobile device in the i-th issuing region, further returning, via the server, a synchronous control instruction to the public mobile device in the i-th issuing region, the synchronous control instruction comprising a current playing location index and an elapsed playing time S, wherein the synchronous control instruction is generated by:
determining a corresponding information content sequence according to the determined address information of the at least node in the at least one trip, the information content sequence comprising each piece of information content ID and a time length of each piece of information content;
calculating a total time length M of the information content sequence within a single cycle;
determining a number of cycles of the played information content sequence corresponding to (i) the current system time, and (ii) a time length L of the played information content in the currently played information content sequence according to a time length K corresponding to (i) the current system time, and (ii) the total time length M of the information content sequence within the single cycle;
determining the current playing location index and the elapsed playing time S according to a sequential accumulative comparison of the determined time length L of the played information content in the currently played information content sequence and the time length of each piece of information content in the information content sequence; and
transmitting the current playing location index and the elapsed playing time S to the public mobile device in the i-th issuing region.

5. The method according to claim 1, wherein the server comprises a first sub-server and a second sub-server, and
wherein the act of acquiring, via the server, the information on the i-th issuing region and the information on the known starting point adjacent to the location of the public mobile device according to the information request received from the public mobile device in the i-th issuing region and the act of determining, via the server, the address information of at least one node in at least one trip starting from the known starting point in the i-th issuing region include:
forwarding, via the first sub-server, the information request from the public mobile device in the i-th issuing region to the second sub-server;
acquiring, via the second sub-server, the information on the i-th issuing region and the information on the known starting point adjacent to the location of the public mobile device;
acquiring, via the second sub-server, a trip schedule starting from the known starting point in the i-th issuing region based on the acquired information on the known starting point in the i-th issuing region;
extracting, via the second sub-server, trip information within a predetermined time range from the trip schedule;
extracting, via the second sub-server, the address information of at least one node in each trip information;
transmitting, via the second sub-server, the address information back to the first sub-server; and
returning, via the first sub-server, the address information of the at least one node to the public mobile device in the i-th issuing region.

6. An information issuing method, comprising:
receiving, via a server, an information issuing request from an information resource provider, the information issuing request comprising information content IDs for N issuing regions, an issuing destination, and an issuing time period related to respective information content IDs, wherein N is a positive integer;
generating, via the server, N information issuing tables corresponding to the N issuing regions according to the received information issuing request, the information issuing table comprising the information content ID, the issuing destination, and the issuing time period related to the respective information content IDs,
transmitting, via the server, the N information issuing tables to a public mobile device within a corresponding issuing region;
detecting, via the public mobile device, first location information in which the public mobile device is located, the public mobile device being located in an i-th issuing region among a plurality of regions, wherein i is a positive integer larger than 0 and less than or equal to N;
when a distance between the first location information and second location information of a known starting point in the i-th issuing region is less than a predetermined distance threshold, counting, via the public mobile device, a duration of time that the public mobile device resided within a range of the predetermined distance threshold from the starting point;
when the duration of time reaches a predetermined time threshold, transmitting, via the public mobile device, an information request for requesting address information of at least one node in at least one trip starting from the starting point, the information request comprising information on the i-th issuing region and the information on the starting point;
determining, via the server, address information of the at least one node in the at least one trip starting from the starting point in the i-th issuing region according to the information on the i-th issuing region and the information on the starting point acquired from the information request;
identifying, via the public mobile device, an issuing destination matched with the address information from the information issuing table received from the server according to the address information returned by the server;
determining, via the public mobile device, related information content ID according to the identified issuing destination;
acquiring, via the public mobile device, the corresponding information content according to the determined information content ID; and
displaying the information content within the corresponding issuing time period.

7. The method according to claim 6, further comprising:
when monitoring at least one additional issuing region existing in the information issuing request from at least one information resource provider, generating, via the server, each corresponding information issuing table with respect to the at least one additional issuing region;
transmitting, via the server, each information issuing table to a public mobile device in at least one related issuing region; and
when monitoring a deletion of at least one issuing region existing in the information issuing request from at least one information resource provider, transmitting, via the server, an instruction to delete the information issuing table to the public mobile device in the at least one deleted region.

8. The method according to claim 6, further comprising:
when monitoring a change of an issuing destination in the information issuing request from at least one information resource provider, generating, via the server, each changed information issuing table corresponding to each issuing region according to the received information issuing request based on the change of the issuing destination; and
transmitting, via the server, each changed information issuing table to a public mobile device in each respective issuing region.

9. The method according to claim 6, further comprising:
returning, via the server, a synchronous control instruction to the public mobile device in the i-th issuing region, the synchronous control instruction comprising a current playing location index and an elapsed playing time S, wherein the synchronous control instruction is generated by: determining a corresponding information content sequence according to the determined address information of the at least node in the at least one trip, the information content sequence comprising each piece of information content ID and a time length of each piece of information content;
calculating a total time length M of the information content sequence within a single cycle;
determining a number of cycles of the played information content sequence corresponding to (i) the current system time, and (ii) a time length L of the played information content in the currently played information content sequence according to a time length K corresponding to (i) the current system time, and (ii) the total time length M of the information content sequence within the single cycle;
determining the current playing location index and the elapsed playing time S according to a sequential accumulative comparison of the determined time length L of the played information content in the currently played information content sequence and the time length of each piece of information content in the information content sequence; and
transmitting the current playing location index and the elapsed playing time S to the public mobile device in the i-th issuing region.

10. The method according to claim 1, wherein the server comprises a first sub-server and a second sub-server, and wherein the act of determining the address information of at least one node in at least one trip starting from the known starting point in the i-th issuing region comprises:
forwarding, via the first sub-server, the information request from the public mobile device in the i-th issuing region to the second sub-server;
acquiring, via the second sub-server, the information on the i-th issuing region and the information on the known starting point adjacent to the location of the public mobile device;
acquiring, via the second sub-server, a trip schedule starting from the known starting point in the i-th issuing region based on the acquired information on the known starting point in the i-th issuing region;
extracting, via the second sub-server, trip information within a predetermined time range from the trip schedule;
extracting, via the second sub-server, the address information of at least one node in each trip information;
transmitting, via the second sub-server, the address information back to the first sub-server; and
returning, via the first sub-server, the address information of the at least one node to the public mobile device in the i-th issuing region.

11. An information pushing system, comprising:
a server configured to:
receive an information issuing request from an information resource provider, the information issuing request comprising information content IDs for N issuing regions, an issuing destination, and an issuing time period related to respective information content IDs, wherein N is a positive integer;
generate N information issuing tables corresponding to the N issuing regions according to the received information issuing request, the information issuing table comprising the information content ID, the issuing destination, and the issuing time period related to the respective information content IDs,
transmit the N information issuing tables to a public mobile device within a corresponding issuing region; and
a public mobile device configured to:
detect first location information in which the public mobile device is located, the public mobile device being located in an i-th issuing region among a plurality of regions, wherein i is a positive integer larger than 0 and less than or equal to N;
when a distance between the first location information and second location information of a known starting point in the i-th issuing region is less than a predetermined distance threshold, count a duration of time that the public mobile device resided within a range of the predetermined distance threshold from the starting point;
when the duration of time reaches a predetermined time threshold transmit an information request for requesting address information of at least one node in at least one trip starting from the starting point, the information request comprising information on the i-th issuing region and the information on the starting point,
wherein the server is further configured to determine address information of the at least one node in the at least one trip starting from the starting point in the i-th issuing region according to the information on the i-th issuing region and the information on the starting point acquired from the information request, and
wherein the public mobile device is further configured to (i) identify an issuing destination matched with the address information from the information issuing table received from the server according to the address information returned by the server, (ii) determine related information content ID according to the identified issuing destination, (iii) acquire the corresponding information content according to the determined information content ID, and (iv) display the information content within the corresponding issuing time period.

12. The system of claim 11, wherein the server is further configured to:
when monitoring at least one additional issuing region existing in the information issuing request from at least one information resource provider, (i) generate each corresponding information issuing table with respect to the at least one additional issuing region, and (ii) transmit each information issuing table to a public mobile device in at least one related issuing region; and
when monitoring a deletion of at least one issuing region existing in the information issuing request from at least one information resource provider, transmit an instruction to delete the information issuing table to the public mobile device in the at least one deleted region.

13. The system according to claim 11, wherein the server is further configured to:
when monitoring a change of an issuing destination in the information issuing request from at least one information resource provider, generate each changed information issuing table corresponding to each issuing region according to the received information issuing request based on the change of the issuing destination, and transmit each changed information issuing table to a public mobile device in each respective issuing region.

14. The system according to claim 11, wherein the server is further configured to:
return a synchronous control instruction to the public mobile device in the i-th issuing region, the synchronous control instruction comprising a current playing location index and an elapsed playing time S, wherein the synchronous control instruction is generated by:
determining a corresponding information content sequence according to the determined address information of the at least node in the at least one trip, the information content sequence comprising each piece of information content ID and a time length of each piece of information content;
calculating a total time length M of the information content sequence within a single cycle;
determining a number of cycles of the played information content sequence corresponding to (i) the current system time, and (ii) a time length L of the played information content in the currently played information content sequence according to a time length K corresponding to (i) the current system time, and (ii) the total time length M of the information content sequence within the single cycle;
determining the current playing location index and the elapsed playing time S according to a sequential accumulative comparison of the determined time length L of the played information content in the currently played information content sequence and the time length of each piece of information content in the information content sequence; and
transmitting the current playing location index and the elapsed playing time S to the public mobile device in the i-th issuing region.

15. The system according to claim 11, wherein the server comprises a first sub-server and a second sub-server, and wherein the server is further configured to determine the address information of at least one node in at least one trip starting from the known starting point in the i-th issuing region by:
forwarding, via the first sub-server, the information request from the public mobile device in the i-th issuing region to the second sub-server;
acquiring, via the second sub-server, the information on the i-th issuing region and the information on the known starting point adjacent to the location of the public mobile device;
acquiring, via the second sub-server, a trip schedule starting from the known starting point in the i-th issuing region based on the acquired information on the known starting point in the i-th issuing region;
extracting, via the second sub-server, trip information within a predetermined time range from the trip schedule;
extracting, via the second sub-server, the address information of at least one node in each trip information;
transmitting, via the second sub-server, the address information back to the first sub-server; and
returning, via the first sub-server, the address information of the at least one node to the public mobile device in the i-th issuing region.
